(19) United States
(12) Patent Application Publication
(10) Pub. No.: US 2011/0132816 A1
(43) Pub. Date: Jun. 9, 2011

(54) Filter Provided with a Clogging Detector and an Assembly for Detecting the Presence of a Filtering Element Therein

(76) Inventor: Dan Vasilescu, Neuilly-sur-Seine (FR)

(21) Appl. No.: 11/794,104

(22) PCT Filed: Dec. 21, 2005
(86) PCT No.: PCT/FR05/03229

§ 371 Date: Sep. 24, 2007

(30) Foreign Application Priority Data
Dec. 24, 2004 (FR) 0413879

(51) Int. Cl. B01D 35/14; B23P 17/04

(52) U.S. Cl. 210/90; 29/464

(57) ABSTRACT

The invention concerns a filtering assembly comprising, firstly, a housing consisting of a case (2) and a lid or filter head (3) sealingly assembled together, secondly, a removable filtering element (4) sealingly connected at one of its ends to the housing, said filtering element (4) consisting of a resistance structure (6) and a filtering material (5) supported on said structure, two cups (7) and (8) being arranged at the ends of said resistance structure, and thirdly, at least one foolproof device comprising a rod (9) integral with the housing (1) and a gap which is provided in the filtering material (6) wherein said rod (9) penetrates (9) when the filtering element (4) is mounted, into at least one cup (7) or (8) an orifice (11) being provided for allowing through said rod (9). The invention is characterized in that it comprises a clogging indicator. The invention is applicable in the field of filtration.

This patent relates to a filter assembly provided with a clogging indicator and its application to detect the presence of a filter element inside.

The filtration is the most common separation technique between solid particles and fluids used in the decontamination circuits. This technique uses filter assemblies located on the circuits and the particle contaminated fluids are circulating through. Such a filter assembly is described for instance in the document FR-2.818.917-A.

A filter assembly contains a filter element comprising especially a filter media that retains the particles contained in the contaminated fluid. While retaining the particles, this filter media will clog in time and at a certain moment it will not fulfil any more completely its function. In the meantime the pressure drop through the filter media will rise. As soon as this pressure drop rise reaches the maximal value indicated by the manufacturer of the filter assembly, it becomes necessary to replace the clogged filter element by a new one.

Actually, there are two methods to determine the pressure drop through a filter element: either by measuring the absolute pressure stream-up of it (the stream-down pressure is supposed being known as the environment pressure) or by measuring the pressure difference between stream-up and stream-down of it.

This measure is usually done by means of pressure sensors or of differential pressure sensors included in so—called “clogging indicators” usually located on the filter head. Clogging indicators are fine mechanics components: they are relatively expensive and their mounting has to be done on machined connecting surfaces or in specially machined cavities. After mounting it is always necessary to proceed to sealing tests to prevent leakage during future operation.

Due to all these reasons the clogging indicators are not commonly used, inspite of the fact that their function is necessary in all application cases.

As in the common applications there are no clogging indicators on filters, this leads to the fact that no information about the clogging of the filter element is available and the criteria used is the operation time that is supposed to be proportional with the clogging level. This criteria is not very precise because at the moment when a filter element is replaced conforming to the maintenance schedule it might be either only partially clogged or totally clogged for a long time.

In the first case it is handling merely about an economical problem, but in the second case there is a real risk of failure for certain components of the circuit.

On the other hand, as the housing of the filter assembly is always closed, one cannot verify if there is a filter element inside of it without opening it. This verification action is in many cases very useful, sometimes it is even required. Actually there is no possibility to prove that there is indeed a filter element without verifying the inner part of the filter assembly.

In the document US-2003/025598-A1 one can find the description of a filter assembly containing a clogging indication: a clogging indicator constituted by a transponder is located on the filter media, the differential pressure is measured for instance by means of a strain gauge and the data are transmitted to a central unit where they are compared with stored data to determine the clogging level of the filter element. This assembly has some inconveniences, especially because the filter media, in this particular case filtering paper is not an elastic material and a strain gauge works only if the ground material is elastic.

So, one of the goals of the invention is a filter assembly containing also a clogging indicator that shall allow one to determine in a very precise way the right moment to replace the filter element.

Another goal of the invention is such a filter assembly containing a clogging indicator that shall allow one to check if there is a filter element inside the filter housing without opening it. These goals, as well as some other goals that will appear later can be reached by a filter assembly comprising first of all a housing constituted by a bowl and a cover or a filter head, that are mounted together in a sealed way, on the other hand a removable filter element connected at one of its ends in a sealed way to the filter housing, said filter element is constituted by a resistance structure and by a filter media supported by this resistance structure, two end caps being disposed at the ends of said resistance structure, and third at least one safety device comprising a pin fixed on the housing and a volume created inside of the filter media in that can penetrate the said pin when mounting the filter element, on at least one end cap existing a hole allowing the pin to penetrate, that assembly characterized by the fact that it comprizes a clogging indicator constituted by:
a connecting subassembly cooperating with the safety device;
a strain gauge cooperating with the first large clip;
an electrical circuit connecting, on one hand, the connecting subassembly and the strain gauge, and on the other hand the safety device with an electricity source and a circuit for the signal conditioning.

In a preferred embodiment, the connecting subassembly is constituted, on one hand by the connectors of the female connector, and on the other hand, by the connectors located on the pin and cooperating each with the connectors of the female connector.

In an advantageous design, the strain gauge is located in the midst of the first large clip and its wire terminals are connected in a known way with the female connector.

In another preferred embodiment, the first large clip contains at its two ends, near the end caps, stamped legs supported by the resistance structure.

In an advantageous design, the filter element is fixed at one of its ends in a sealed way on the filter head.

Following another way to create, the filter element is fixed at one of its ends in a sealed way on the filter bow.

Following another preferred embodiment of the invention, the strain gauge is located on the first large clip.

The invention concerns also the possibility to check if there is a filter element inside of the housing of a filter assembly as described before.

In an advantageous design it is possible to connect an electrical source to check if the electrical loop is closed.

The invention will be described in further detail hereinafter with reference to the structure and operation of preferred embodiments shown in the accompanying figures in which:

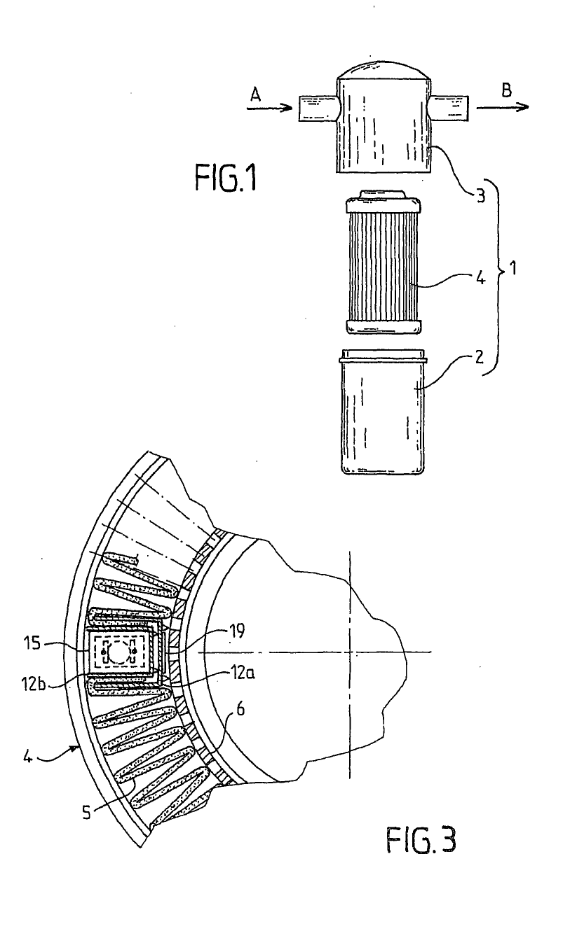

FIG. 1 shows an exploded view of a filter assembly;

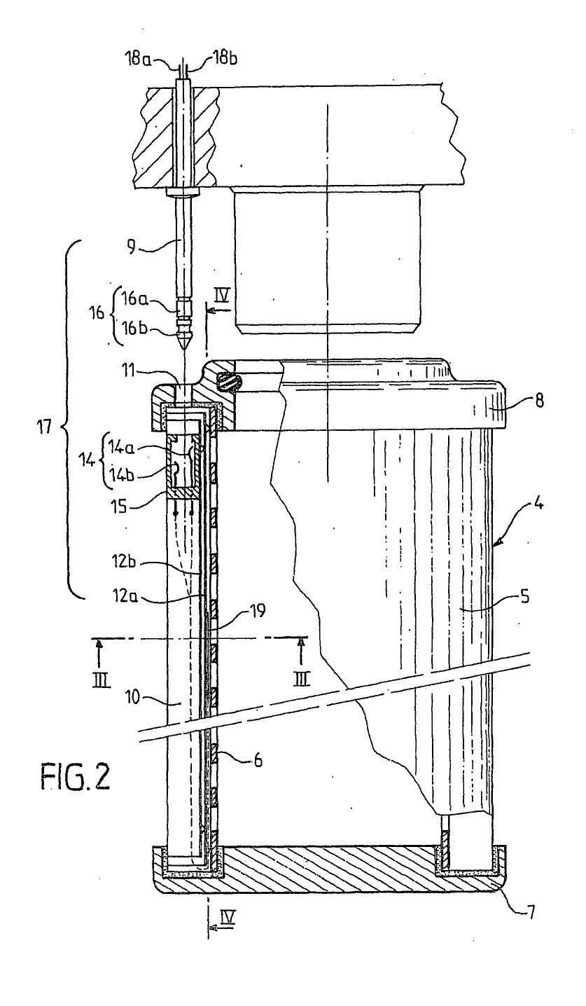

FIG. 2 shows a partially exploded view of the filter element of the filter assembly according to FIG. 1;

FIG. 3 is a cross-section view according to III-III in FIG. 2;

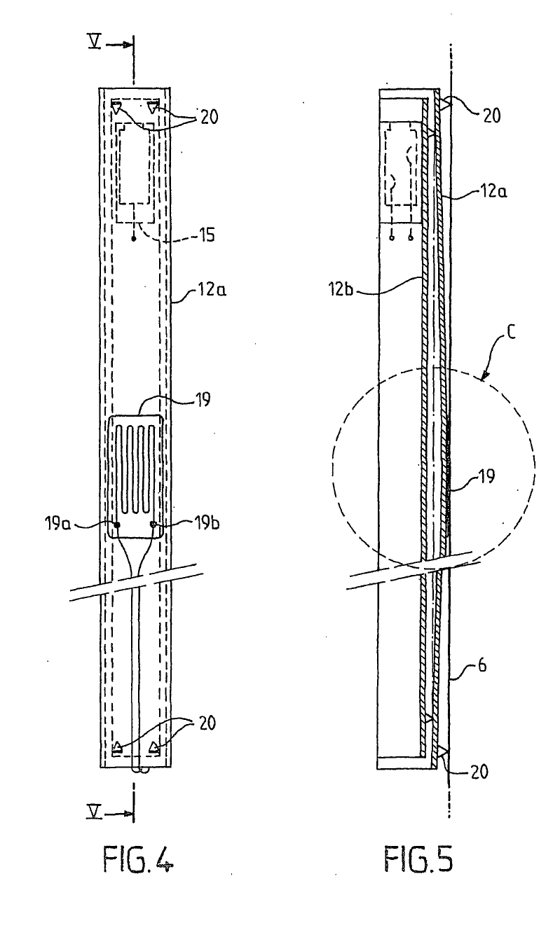

FIG. 4 is a cross-section view according to IV-IV in FIG. 2;

FIG. 5 is a cross-section view according to V-V in FIG. 4 and

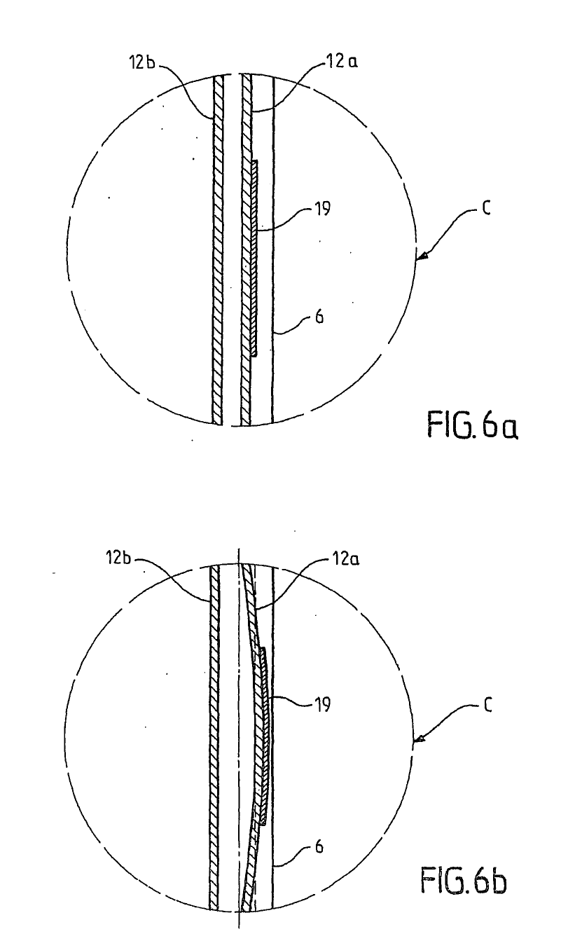

FIG. 6a is a view of part “C” at a larger scale of FIG. 5 unloaded, and

FIG. 6b is a view of part “C” at a larger scale of FIG. 5 loaded.

As one can see in FIG. 1, a filter assembly referenced 1, comprizes a housing that is constituted by a bowl 2 and by a cover or filter head 3, mounted together in a sealed way, and a filter element 4, dismountable and mounted in a sealed way at one of its ends on the filter head 3. Following another way to create this filter element 4 can be mounted at one of its ends in a sealed way on the bowl 2.

The filter assembly 1 is mounted on a circuit, a closed or an open one, in which the contaminated fluid crosses it from A to B.

The filter element 4 contains a resistance structure 6 and a filter media 5 supported by said resistance structure, two end caps 7 and 8 being disposed at the ends of this resistance structure. The filter media 5 is for instance pleated and disposed in a regular way around or inside of the resistance structure 6.

The filter assembly 1 contains at least one safety device comprising a pin 9 fixed on the housing 1 and a volume 10 inside the filter media 6 in which penetrates said pin when mounting the filter element 4. In at least one of the end caps 7 or 8 one can find a hole 11 allowing the pin 9 to penetrate.

The volume 10 conforming to the invention is created by the large clip 12a that joins the two ends of the filter media 5, and by a second large clip 12b that joins also the two ends of the filter media 5, in a way to create a volume delimited by its own shape and by the two end caps 7 and 8. The second large clip 12b is not fixed on the first large clip 12a and it does not follow its distortions. Its function is to stuck the ends of the filter media 5 and on the other hand to support the female connector 15 as described further.

Such a filter assembly is described in the document FR-2 818 917-A.

Conforming to the invention, this filter assembly comprizes a clogging indicator assembly referenced 17 and constituted by:
a connecting assembly 14 cooperating with the safety device 9;
a strain gauge 19 cooperating with the first large clip 12a; and
an electrical circuit connecting, on one hand the connecting assembly 14 and the strain gauge 19, and on the other hand the safety device 9 with an electricity source and with a circuit for the signal conditioning made in a known way and located on the outer part of the filter assembly 1 conforming to the description (not represented on the figures).

Following a first way to create, the strain gauge 19 is located in the midst of the first large clip 12a, facing the resistance structure 6.

The clogging indicator 17 comprizes a connecting assembly 14 cooperating with the safety device 9. This connecting assembly 14 is constituted on one hand by the connectors 14a and 14b of the female connector 15 and on the other hand by the two connectors 16a and 16b cooperating respectively with the connectors of the female connector.

The connectors 16a and 16b are each electrically connected with the terminals 18a and 18b which allow the connection to an electricity source and to a conditioning circuit of the signal—not represented here. These terminals 18a and 18b are located outside the filter housing 1, for instance on the filter head 3.

This clogging indicator 17 comprizes also a sensor as a strain gauge 19 located on the first large clip 12a. Conforming to a preferred way to make, this strain gauge 19 is located midst of the first large clip 12a as shown in FIG. 6a. The terminals 19a and 19b of the strain gauge are electrically connected in a known way with the connectors 14a and 14b respectively.

In a preferred embodiment of this invention, the first large clip 12a comprizes at its ends, near the two end caps 7 and 8, stamped legs 20 supported by the resistance structure 6: this allows to create a sufficient gap for the bending of this first large clip 12a to avoid the contact with the resistance structure during service operation.

As it can be understood by people in the profession, the sensor i.e the strain gauge 19 is fixed on the first large clip 12a that is neither a part of the filter media, nor a part of the resistance structure 6 of the filter element 4.

During service operation the filter element 4 will be charged by particles that will clog it; this leads to a rise of the pressure drop increasing the bending of the first large clip 12a towards the resistance structure 6 as shown in FIG. 6b.

The bending of the first large clip 12a is that of a beam and it is transmitted to the strain gauge 19 that is attached on it. In the design shown this bending will cause the straining of the surface of the first large clip 12a towards the resistance structure 6 and following the straining of the strain gauge 19: the electrical resistance in this strain gauge will rise and this will be detected by means known by people in the profession.

In a filter assembly conforming to the invention comprising a clogging indication one can also check if there is a filter element inside of the filter housing. This control operation can be done either during operation service or while the circuit is stopped by sending an electrical signal on the terminal 18a for instance. If there is no filter element inside of the filter housing there will be no electrical signal back on the terminal 18b. If there is a filter element inside, this electrical signal will travel up and down the electrical circuit closed at the level of the connectors 14a and 14b of the female connector 15 cooperating with the connectors 16a and 16b of the pin 9: in this way one gets the evidence that there is a filter element inside of the filter housing without opening it.

If the function of the clogging indication is not necessary, there will be no strain gauge mounted inside of the filter element. In this application the connectors 14a and 14b of the female connector 15 will be shunted and it will be possible only to check if there is a filter element inside the housing of the filter assembly.

1: Filter assembly comprizing, first, a housing composed by the bowl (2) and by a cap or a filter head (3) assembled in a detachable and sealed way, and second, a filter element (4), detachable and connected at one of its ends in a sealed way on the filter head (3) or on the bowl (2), said filter element (4) comprising a resistance structure (6) and the filter media (5) supported by said resistance structure, two end caps (7) and (8) being disposed on the ends of said resistance structure, and third, at least one safety device comprising a pin (9) fixed on the housing (1) and a volume (10) created in the filter media (6) in that can penetrate said pin (9) when mounting the filter element (4), on at least one of the end caps (7) or (8) existing a hole (11) allowing the pin (9) to penetrate, characterized by the fact that it is comprised a clogging indication (17) composed of:
a connecting assembly (14) cooperating with the pin (9);
a strain gage (19) cooperating with the first large clip (12a);
an electrical circuit connecting, on one hand, the connecting assembly (14) and the strain gage (19), and on the other hand, the pin (9) with an electrical energy source and a data processing circuit.

2: Filter assembly according to claim 1, characterized by the fact that the connecting assembly (14) is composed, on one hand, by two connectors (14a) and (14b) of the female connector (15), and on the other hand, by two connectors (16a) and (16b) located on the pin (9) cooperating respectively with the connectors (14a) and (14b).

3: Filter assembly according to claim 1, characterized by the fact that the strain gage (19) is located midst on the first large clip (12a), the lead connections of the strain gage, (19a) and (19b) are electrically connected in a known way with the connectors (14a) and (14b).

4: Filter assembly according to claim 1, characterized by the fact that the first large clip (12a) comprises at its ends, near the end caps (7) and (8), means (20) that are supported by the resistance structure (6) to create a gap.

5: Filter assembly according to claim 1, characterized by the fact that the filter element (4) is mounted on one of its ends in a sealed way on the filter head (3).

6: Filter assembly according to claim 1, characterized by the fact that the filter element (4) is mounted on one of its ends in a sealed way on the filter bowl (2).

7: Filter assembly according to claim 1, characterized by the fact that the strain gage (19) is located on the first large clip (12a).

8: Application of a filter assembly according to claim 1 to detect the presence of a filter element (4) inside of the housing of the said filter assembly.

9: Application according to claim 8 characterized by the fact that one can induce an electrical signal into the connecting assembly (14) to check if the electrical loop is closed.
